(19) United States
(12) Patent Application Publication
(10) Pub. No.: US 2006/0266731 A1
(43) Pub. Date: Nov. 30, 2006

(54) Etchant rinse method

(76) Inventors: Steven Y. Yu, Austin, TX (US); Pei-San Tseng, Austin, TX (US); Nanayakkara L. Somasiri, Austin, TX (US)

Correspondence Address: 3M INNOVATIVE PROPERTIES COMPANY, PO BOX 33427, ST. PAUL, MN, 55133-3427, US

(21) Appl. No.: 11/140,804

(22) Filed: May 31, 2005

(51) Int. Cl. H01B 13/00; B44C 1/22; C23F 1/00

(52) U.S. Cl. 216/13; 216/83

(57) ABSTRACT

Method of removing iodine from a polymer using a thiosulfate solution.

### TECHNICAL FIELD

This invention relates to a method of rinsing an etched article to prevent delamination.

### BACKGROUND

Gold-coated circuits are useful in corrosive environments. Gold-coated circuits often have a copper trace on a polymer substrate, a chrome tie layer on the copper layer, and a gold coating on the chrome tie layer. Alternatively, the copper layer may be eliminated. In making gold-coated circuits, it is often necessary to etch the gold to form trace patterns. A tri-iodide (I₃⁻) solution is normally used to etch the gold. The net reaction for gold etching in the presence of tri-iodide is the following:
2Au+I₃⁻+I⁻→2AuI₂⁻

The tri-iodide solution can be absorbed in the form of iodine (12) by the photoresist that is used as a mask during the etching process. Although the etchant is normally rinsed from the circuit using deionized (D. I.) water or solvents such as methanol, ethanol, or isopropanol, iodine/iodide typically remains in the photoresist.

### SUMMARY

Iodine absorption by the photoresist or polymer substrate can lead to gold/chrome interface failure because residual iodine can cause continued oxidation of the chrome tie layer, which can cause the gold traces to delaminate from the chrome tie layer. There remains a need for a way to remove iodine from a polymer such as a photoresist or substrate.

One aspect of the present invention features a method comprising: providing a polymer containing iodine, exposing the polymer to a solution containing a thiosulfate salt, wherein such exposure causes at least a portion of the iodine to be removed from the polymer.

Another aspect of the present invention features a method comprising: providing an article comprising a metal layer on a polymer layer, etching at least a portion of the metal layer with a tri-iodide etchant, and exposing the article to a solution containing a thiosulfate salt.

Other features and advantages of the invention will be apparent from the following drawings, detailed description, and claims.

### BRIEF DESCRIPTION OF DRAWINGS

FIG. 1 shows a digital image of a circuit treated according to a prior art method.

FIG. 2 shows a digital image of a circuit treated according to an embodiment of the present invention.

FIGS. 3a-3b show digital images of circuits that have been heat treated only.

FIG. 4 shows a digital image of a circuit treated according to an embodiment of the present invention.

FIGS. 5a-5c show digital images of circuits treated according to an embodiment of the present invention.

### DETAILED DESCRIPTION

An aspect of the present invention provides a chemical process to remove iodine/iodide from a polymer. Another aspect of the present invention provides a chemical process to reduce or prevent undercutting and subsequent delamination of metal, e.g., gold circuits having tie layers, e.g., chrome tie layers, after a tri-iodide gold etching process. In another aspect of the present invention, a thermal process can be used in addition to the chemical process to further reduce undercutting and delamination.

One aspect of the present invention provides a thiosulfate rinse for removing iodine/iodide from a polymer. Suitable thiosulfate salts include sodium thiosulfate, potassium thiosulfate, and lithium thiosulfate. The thiosulfate rinse can reduce or eliminate residual iodine/iodide absorbed into a polymer such as a photoresist covering a metal circuit or a polymer substrate underlying a metal circuit. The present invention is suitable for use with any type of polymer that absorbs iodine/iodide. The thiosulfate rinse may be applied at room temperature, or may be heated. If heated, typical temperatures are from about 50° C. to about 60° C.

Another aspect of the present invention provides a thiosulfate rinse followed by baking. The baking can further reduce the amount of residual iodine/iodide in the polymer. Suitable baking temperatures are from about 90° C. to about 120° C., typically about 100° C.

While the present invention is useful for all types of metal circuits, e.g., copper, tin, silver, etc., the remainder of this section will address gold circuits as an example.

Gold circuits may be made by a number of suitable methods that include a gold etching step, such as subtractive, additive-subtractive, and semi-additive. The gold can be etched with various chemicals including cyanide-based chemistries, thiourea, and tri-iodide type solutions. However, due to toxicity and environmental issues of cyanide-based chemistries, as well as performance limitations of thiourea-based chemistries, tri-iodide-based etchants are becoming more prevalent.

In a typical subtractive circuit-making process, a dielectric substrate is first provided. The dielectric substrate may be a polymer film made of, for example, polyester, polyimide, liquid crystal polymer, polyvinyl chloride, acrylate, polycarbonate, or polyolefin usually having a thickness of about 10 μm to about 600 μm. The dielectric substrate typically has a tie layer of chrome, nickel-chrome or other conductive metal deposited on its surface by a method such as chemical vapor deposition or magnetron sputter deposition, followed by deposition of a gold conductive layer such as by magnetron sputtering. Optionally, the deposited gold layer(s) can be plated up further to a desired thickness by known electroplating or electroless plating processes.

The conductive gold layer can be patterned by a number of well-known methods including photolithography. If photolithography is used, photoresists, which may be aqueous or solvent based, and may be negative or positive photoresists, are then laminated or coated on at least the gold-coated side of the dielectric substrate using standard laminating techniques with hot rollers or any number of coating techniques (e.g., knife coating, die coating, gravure roll coating, etc.). A variety of photo-sensitive polymers may be used in photoresists. Examples include, but are not limited to, copolymers of methyl methacrylate, ethyl acrylate and acrylic acid, copolymers of styrene and maleic anhydride isobutyl ester, and the like. The thickness of the photoresist is typically from about 1 μm to about 50 μm. The photoresist is then exposed to ultraviolet light or the like, through a mask or phototool, crosslinking the exposed portions of the resist. The unexposed portions of the photoresist are then developed with an appropriate solvent until desired patterns are obtained. For a negative photoresist, the exposed portions are crosslinked and the unexposed portions of the photoresist are then developed with an appropriate solvent.

The exposed portions of the gold layer are etched away using an appropriate etchant. Then the exposed portions of the tie layer are etched away using a potassium permanganate etchant, or other suitable etchant. The remaining (unexposed) conductive metal layer preferably has a final thickness from about 5 nm to about 200 μm. The crosslinked resist is then stripped off of the laminate in a suitable solution.

If desired the dielectric film may be etched to form features in the substrate. Subsequent processing steps, such as application of a covercoat and additional plating may then be carried out.

Another possible method of forming the circuit portion would utilize semi-additive plating and the following typical step sequence:

A dielectric substrate may be coated with a tie layer of chrome, nickel-chrome or alloys thereof using a vacuum sputtering or evaporation technique. A thin first conductive layer of gold is deposited using a vacuum sputtering or evaporation technique. The materials and thicknesses for the dielectric substrate and conductive gold layer may be as described in the previous paragraphs.

The conductive gold layer can be patterned in the same manner as described above in the subtractive circuit-making process. The first exposed portions of the conductive gold layer(s) may then be further plated using standard electroplating or electroless plating methods until the desired circuit thickness in the range of about 5 nm to about 200 μm is achieved.

The crosslinked exposed portions of the resist are then stripped off. Subsequently, the original thin gold layer(s) is/are etched where exposed with an etchant, such as a triiodide etchant, that does not harm the dielectric substrate. If the tie layer is to be removed where exposed, it can be removed with appropriate etchants. If the tie layer is a thin metal, an insulator, or an organic material, it may be desirable to leave the tie layer in place.

If desired the dielectric film may be etched to form features in the substrate. Subsequent processing steps, such as application of a covercoat and additional plating may then be carried out.

Another possible method of forming the circuit portion would utilize a combination of subtractive and additive plating, referred to as a subtractive-additive method, and the following typical step sequence:

A dielectric substrate may be coated with a tie layer of, e.g., chrome, nickel-chrome or alloys thereof using, e.g., a vacuum sputtering or evaporation technique. A thin first conductive gold layer is deposited using a vacuum sputtering or evaporation technique. The materials and thicknesses for the dielectric substrate and conductive gold layer may be as described in the previous paragraphs.

The conductive gold layer can be patterned by a number of well-known methods including photolithography, as described above. When the photoresist forms a positive pattern of the desired pattern for the gold layer, the exposed gold is typically etched away using a triiodide-based etchant. The tie layer is then etched with a suitable etchant. The remaining (unexposed) conductive gold layer preferably has a final thickness from about 5 nm to about 200 μm. The exposed (crosslinked) portion of the resist is then stripped.

If desired the dielectric film may be etched to form features in the substrate. Subsequent processing steps, such as application of a covercoat and additional plating may then be carried out.

As can be seen from the foregoing, each described process includes chemical-etching of gold. Current technologies for chemical gold etching include tri-iodide-based chemistries such as those available under the trade designations GE-8148 and GE-8111 from Transene Company Inc. (Danvers, MA), cyanide-based chemistries such as those available under the trade designation Techni Strip AU from Technic Inc. (Irving, TX), and thiourea (CH₄N₂S)-based chemistries. Cyanide-based chemistries for gold etching have been extensively developed by gold production and microelectronic industries. “Free”cyanide chemistries including potassium and sodium cyanide etchants are readily available, and are economically viable solutions for high volume gold etching processes. However, due to environmental concerns, as well as the industrial hazard of cyanide poisoning, such chemistry is not typically desirable. Thiourea based chemistries are recent developments. However, due to a limited shelf life of the chemistry, it is not appropriate for long-term production. Therefore, tri-iodide based chemistries, which exhibit low toxicity to operators, provide a viable production path for gold etching.

The primary limitation with tri-iodide chemistry is that it is readily absorbed by and can oxidize organic materials, including photoresist and substrate polymers. Moreover, iodine can sublimate from organic materials, and continue to react with adjacent materials to cause further degradation. Therefore, it is desirable to neutralize the absorbed iodine to inhibit the continued degradation of circuit features. Iodine (I₂) is the form, which is more difficult to remove from the polymer.

In accordance with embodiments of the present invention, to neutralize the iodine that has been absorbed into the photoresist, a thiosulfate rinse such as a sodium thiosulfate rinse and, optionally, a thermal treatment can be used. The mechanism by which sodium thiosulfate assists in the removal of iodine (I₂) from polymers is theorized to be by reducing I₂, which is water insoluble, to ionic iodide, I⁻, which is water soluble, as described by equation,
I₂+2S₂O₃⁻³→2I⁻+S₄O₆⁻²

The newly reduced iodide can then be extracted from the polymer with subsequent deionized water rinses. A subsequent thermal treatment can then optionally be used to sublimate out any remaining trapped iodine.

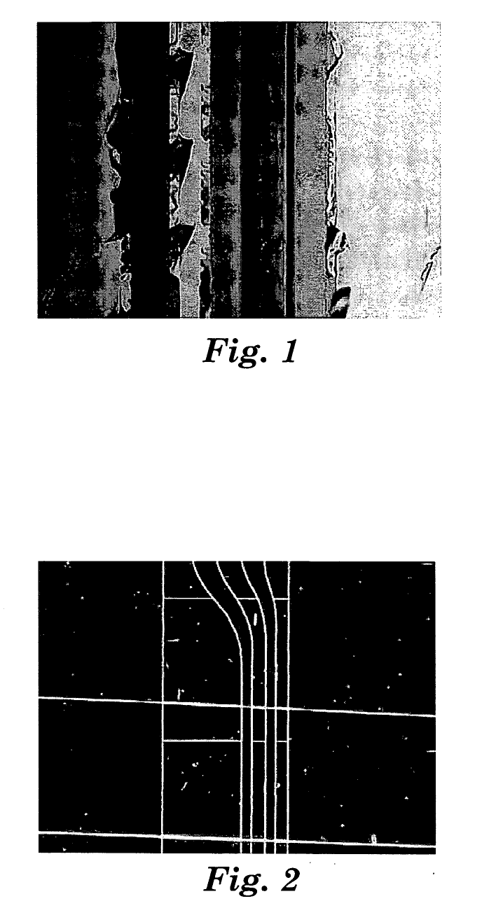

The utility of the sodium thiosulfate rinse and optional thermal process, after tri-iodide gold etching, is that it inhibits debonding of gold circuit from the chrome tie layer on flexible circuits. Without such post-treatment, the iodine absorbed by photoresist and/or a polymer substrate can accelerate the degradation of the chrome/gold interface within 6 to 24 hours of tri-iodide etch and deionized water rinse, as shown by the circuit in FIG. 1, which was made in the manner described in Comparative Example 1, infra. With a sodium thiosulfate rinse, and optional thermal treatment, the time frame within which the chrome/gold interface is stable can be extended to greater than 7 days, as shown by the circuit in FIG. 2, which was made in a manner similar to that described in Example 1, infra. Suitable concentrations for thiosulfate rinses are from about 0.4 M to about 0.75 M. Suitable temperatures for an optional bake step will vary depending on the temperature stability of the photoresist and polymer substrate. For polyimide a suitable range of thermal treatment temperatures are about 90° C. to about 120° C., typically about 100° C. The dwell time of the substrate in the solution will depend on a number of factors, but the substrate is typically exposed to the solution for about one minute or more.

### EXAMPLES

This invention may be illustrated by way of the following examples.

### TEST METHODS

Tape Pull Test

The tape pull test consisted of applying 1/2″ 3M 1280 electroplating tape along bare gold circuits. A minimum of 1″ length of tape was applied onto the features or circuits, and then rolled by hand using a 3-inch diameter rubber roller to ensure adhesion to the circuits. The tape was then removed by hand, being peeled at an angle of about 90°. This process was repeated twice to study the delamination of gold features or circuits from the dielectric substrate.

Comparative Example 1

Tri-iodide gold etching and water rinsing

Comparative Example 1 was made from a sample of polyimide film with a 30% optical transparent chrome tie layer, a gold layer with a thickness of 120 nm on the tie layer, and a layer of photoresist available under the trade designation Accuimage KG 5120 from Kolon Industries, Inc. (Korea) patterned on the gold layer. To etch the exposed gold to form patterned gold features, the sample was submerged for 45 seconds to 1 minute in a constantly stirred (at least 400 RPM) solution of Transene GE8111 etchant, full strength, at room temperature. Thereafter, the sample was rinsed in high-purity deionized water for 1 minute at room temperature. Then the sample was air-dried and stored in a plastic bag for 24 hours at room temperature. Thereafter, it was dipped in 10% potassium hydroxide solution for 2 minutes to remove photoresist at room temperature. Then the sample was rinsed in high-purity deionized water for 1 minute at room temperature, after which it was air-dried and then tape pull tested, following the test method described above under “Tape Pull Test”. After the tape pull test, the circuits experienced uniform 15 micron undercut of the gold features. A sample of Comparative Example 1 is shown in FIG. 1.

Comparative Examples 2a and 2b

Thermal Process Only

Comparative Examples 2a and 2b were made from two samples of polyimide with a 30% optical transparent chrome tie layer, a gold layer with a thickness of 120 nm on the tie layer, and a layer of patterned Kolon Accuimage KG 5120 photoresist on the gold layer. To etch the exposed gold to form patterned gold features, the samples were submerged for 45 seconds to 1 minute in a constantly stirred (at least 400 RPM) solution of Transene GE8111 etchant, full strength, at room temperature. Thereafter, the samples were rinsed in high-purity deionized water for 1 minute at room temperature. Then, the samples were baked in a high air flow oven at 100 C. for 45 minutes, after which they were air-cooled and stored in a plastic bag at room temperature for 24 hours (Example 2a) and 48 hours (Example 2b), respectively. Thereafter, they were dipped in 10% potassium hydroxide solution for 2 minutes to remove photoresist at room temperature. Then, the samples were rinsed in high-purity deionized water for 1 minute at room temperature, after which they were air-dried and then tape pull tested, following the test method described above under “Tape Pull Test”. A sample of Comparative Example 2a is shown in FIG. 2a. This sample showed no delamination. A sample of Comparative Example 2b is shown in FIG. 2b. This sample shows circuit delamination.

Example 3

Sodium Thiosulfate Rinse Only

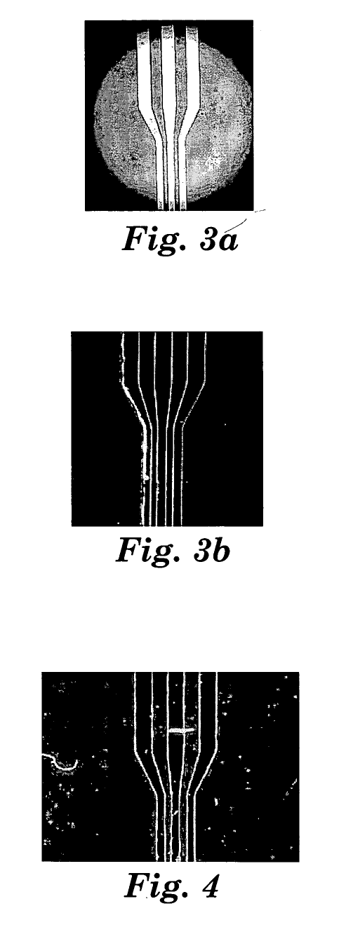

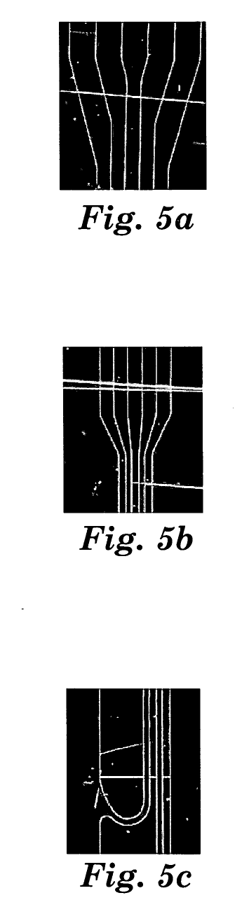

Example 3 was made from a sample of polyimide with a 30% optical transparent chrome tie layer, a gold layer with a thickness of 120 nm on the tie layer, and a layer of patterned KolonAccuimage KG 5120 photoresist on the gold layer. To etch the exposed gold to form patterned gold circuits, the sample was submerged for 45 seconds to 1 minute in a constantly stirred (at least 400 RPM) solution of Transene GE8111 etchant, full strength, at room temperature. Thereafter, the sample was rinsed in high-purity deionized water for 1 minute at room temperature. Then, the sample was rinsed in 0.5 M sodium thiosulfate solution (ACS grade sodium thiosulfate in 18.2 Mohm-cm water) at 50° C. for 1 minute, after which it was rinsed in high-purity deionized water for 1 minute at room temperature. Thereafter, the sample was air-dried and stored in plastic bags for 96 hours at room temperature. Thereafter, it was dipped in 10% potassium hydroxide solution for 2 minutes to remove photoresist at room temperature. Then the sample was rinsed in high-purity deionized water for 1 minute at room temperature, after which it was air-dried and then tape pull tested, following the test method described above under “Tape Pull Test”. A sample of Example 3 is shown in FIG. 3. This sample shows only slight delamination of the circuit edges as a bright and shiny boundary around the circuits.

Example 4

Combination Sodium Thiosulfate Rinse and Thermal Process

Example 4 was made from a sample of polyimide with a 30% optical transparent chrome tie layer, a gold layer with a thickness of 120 nm on the tie layer, and a layer of patterned Kolon Accuimage KG 5120 photoresist on the gold layer. To etch the exposed gold to form patterned gold circuits, the sample was submerged for 45 seconds to 1 minute in a constantly stirred (at least 400 RPM) solution of Transene GE8111 etchant, full strength, at room temperature. Thereafter, the sample was rinsed in high-purity deionized water for 1 minute at room temperature. Then the sample was rinsed in 0.5 M sodium thiosulfate solution (ACS grade sodium thiosulfate in 18.2 Mohm-cm water) at 50° C. for 1 minute, after which it was rinsed in high-purity deionized water for 1 minute at room temperature. Then the sample was baked in a high air flow oven at 100° C. for 45 minutes, after which it was air-cooled and stored in a plastic bag at room temperature for 120 hours. Thereafter, it was dipped in 10% potassium hydroxide solution for 2 minutes to remove photoresist at room temperature. Then the sample was rinsed in high-purity deionized water for 1 minute at room temperature, after which it was air-dried and then tape pull tested, following the test method described above under “Tape Pull Test”. A sample of Example 4 is shown in FIGS. 4a-c. The sample shows no delamination of circuits.

Various modifications and alterations of this invention will become apparent to those skilled in the art without departing from the scope and spirit of this invention and it should be understood that this invention is not to be unduly limited to the illustrative embodiments set forth herein.

What is claimed is:

1. A method comprising:
providing a polymer containing iodine, exposing the polymer to a solution containing a thiosulfate salt, wherein such exposure causes at least a portion of the iodine to be removed from the polymer.

2. The method of claim 1 wherein the thiosulfate salt is selected from the group consisting of sodium thiosulfate, potassium thiosulfate, and lithium thiosulfate.

3. The method of claim 2 wherein the thiosulfate salt is sodium thiosulfate.

4. The method of claim 3 wherein the solution has a sodium thiosulfate concentration of about 0.4 M to about 0.75 M.

5. The method of claim 1 wherein the solution is heated.

6. The method of claim 1 wherein the polymer is a photoresist layer.

7. The method of claim 1 wherein the polymer is a polyimide.

8. The method of claim 1 wherein the article is exposed to the solution for at least one minute.

9. The method of claim 1 wherein the polymer is subsequently exposed to a thermal treatment.

10. The method of claim 9 wherein the thermal treatment is in a temperature range of from about 90° C. to about 120° C.

11. A method comprising:
providing an article comprising a metal layer on a polymer layer, etching at least a portion of the metal layer with a tri-iodide etchant, and exposing the article to a solution containing a thiosulfate salt.

12. The method of claim 11 wherein the article further comprises a patterned photoresist layer on the metal layer.

13. The method of claim 1 1 wherein the metal is gold.

14. The method of claim 11 wherein the article further comprises a tie layer between the metal and polymer layers.

15. The method of claim 14 wherein the tie layer is chrome.

16. The method of claim 11 wherein the thiosulfate salt is selected from the group consisting of sodium thiosulfate, potassium thiosulfate, and lithium thiosulfate.

17. The method of claim 16 wherein the thiosulfate salt is sodium thiosulfate.

18. The method of claim 17 wherein the solution has a sodium thiosulfate concentration of about 0.4 M to about 0.75 M.

19. The method of claim 11 wherein the polymer is polyimide or polyester.

20. The method of claim 11 wherein the polymer is subsequently exposed to a thermal treatment.

21. The method of claim 20 wherein the thermal treatment temperature range is about 90° C. to about 120° C.
